(19) United States
(12) Patent Application Publication
(10) Pub. No.: US 2009/0070831 A1
(43) Pub. Date: Mar. 12, 2009

(54) Interactive Hospitality System for an Exchange of Data

(76) Inventors: Lutz Bardehle, Salzkotten-Upsprunge (DE); Wolfgang Bruggemeier, Delbruck (DE); Dieter Klaus, Delbruck (DE); Thorsten Laux, Paderbom (DE); Bernd Solow, Kleinmachnow (DE); Jurgen Totzke, Poing (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/853,346

(22) Filed: Sep. 11, 2007

(51) Int. Cl. H04N 7/18

(52) U.S. Cl. 725/78

(57) ABSTRACT

A hospitality system, has a media distribution system with a selection to access information and configured to direct information to a display within a guest room, and a link connecting the media distribution system and a services platform to transmit information between the services platform and the media distribution system, wherein the media distribution system has an interface configured to be connected with a mobile electronic appliance and for exchanging data with the appliance. The hospitality system can be used by a guest, wherein the guest brought the mobile electronic appliance.

### FIELD OF THE INVENTION

The present invention relates to an interactive hospitality system and more particularly to an entertainment and messaging system used in hotels.

### BACKGROUND OF THE INVENTION

There are many types of electronic appliances supporting the comfort of a guest in a hotel or e.g. in a hospital. Today's hospitality systems usually support a subscription of video or audio information like movies, music etc. which are displayed by an in-room screen or played by in-room loudspeakers.

### SUMMARY OF THE INVENTION

A hospitality system is configured to store information regarding guests utilizing guest rooms. The system includes a media distribution system including a selection to access information and configured to direct said information to a display within said guest room. The system further includes a services operation platform for receiving selection information from the guest and a multi-media processing system responsive to the selection. The network further includes an interface configured to be connected with a mobile a guest's mobile electronic appliance and for interactively exchanging data with said guest.

In one aspect, an interactive hospitality system comprises means for processing multimedia information by the media distribution system, an interface for coupling a guest's mobile electronic appliance to the media distribution system and a plurality of interactive devices coupled to the media distribution system. The guest's mobile electronic appliance is e.g. a personal digital assistant (PDA), a mobile phone, a digital camera, or a portable computer.

Thus one problem with existing hospitality systems can be overcome. The new hospitality system is fully interactive. The system allows a user to interactively access information without requiring special equipment. The hospitality system has e.g. a common interface like USB™, FireWire™, IEEE 1394, LAN, Bluetooth™ or a combination thereof for a connection with the mobile electronic appliance.

### BRIEF DESCRIPTION OF THE DRAWINGS

FIG. 1 is a block diagram of a prior art hospitality system.

FIG. 2 is a block diagram of a general embodiment of an interactive hospitality system.

### DETAILED DESCRIPTION OF THE INVENTION

The following description is presented to enable one of ordinary skill in the art to make and use the invention. Various modifications to the preferred embodiment will be readily apparent to those skilled in the art and the generic principles and features described herein may be applied to other embodiments. Thus the present invention is not intended to be limited to the embodiment shown but is to be accorded the widest scope consistent with the principles and features described herein.

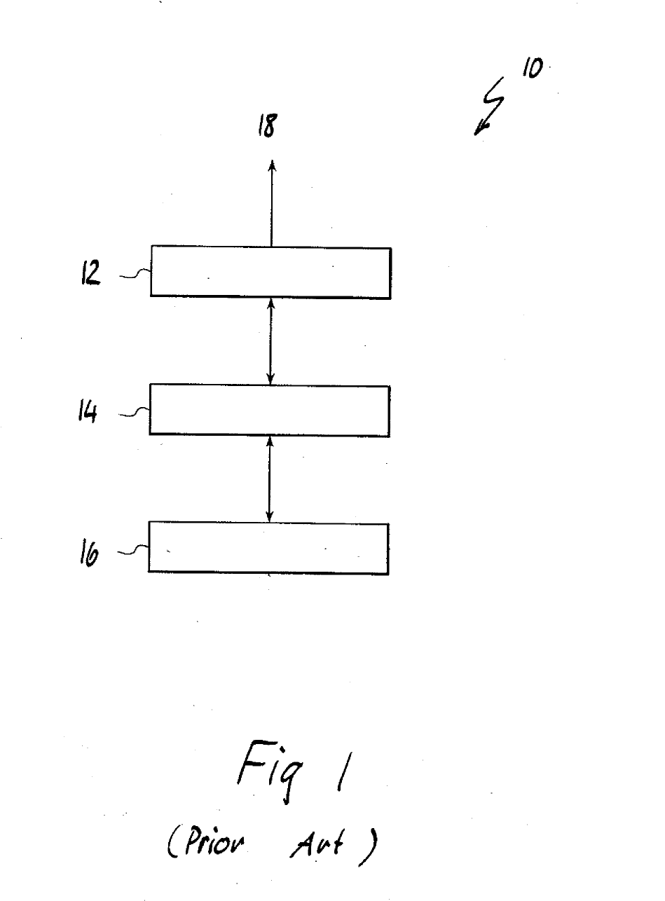

Referring now to FIG. 1, what is shown in simple block diagram form is a prior art hospitality system. In the following discussion the present invention will be discussed in the context of a hotel system. It should be understood however that there are other types of hospitality systems such as hospitals, educational institutions, pleasure boats or the like where the principles of the present invention would apply.

The system 10 includes a communication system 12 for connecting to a data network 18 and for receiving and transmitting telephone calls. The communication system 12 is connected to a communication and/or data network 18. The system 10 further includes a services platform 14 and a media distribution system 16 which could be used to select and access movies, music, web pages or the like. The media distribution system 16 includes an in-room remote link (not shown) for a selection of desired media and is further connected to the services operation platform 14. The services platform 14 keeps track of the users that order desired media and may be linked to a mass storage system (not shown) containing stored media. Alternatively, desired media ordered by the guest is subscribed via the data network 18 from a (not shown) media server. The media distribution system 16 communicates with a (not shown) in-room remote control for a selection to access information. The media information is displayed via a (not shown) display within said guest room.

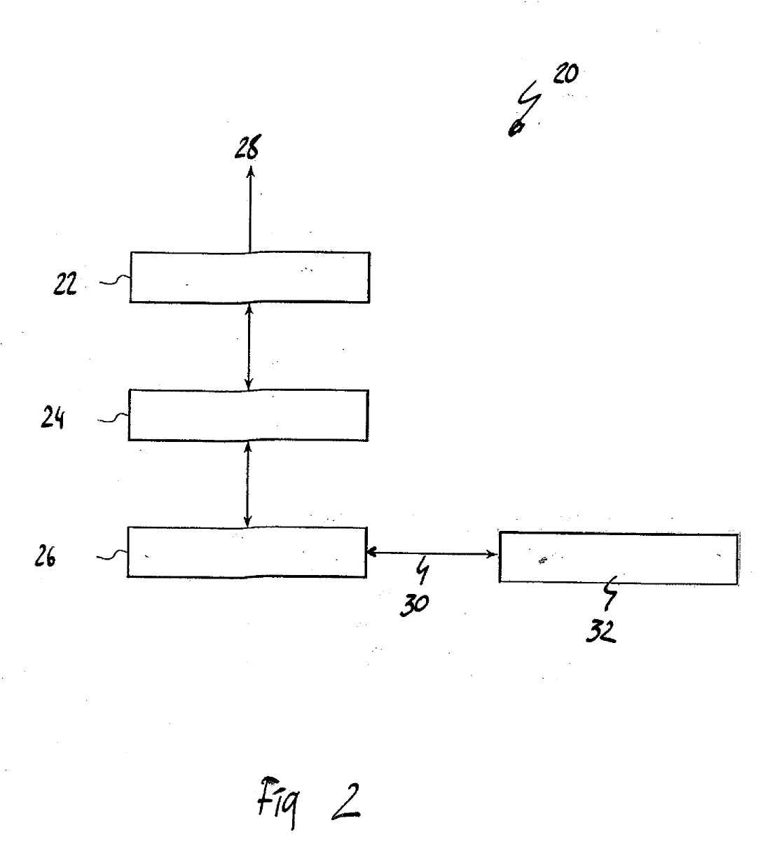

Referring now to FIG. 2, what is shown in simple block diagram form is a hospitality system according to one aspect of the invention.

The system 20 includes a communication system 22 for connecting to a data network 18 and for receiving and transmitting telephone calls. The communication system 22 is connected to a communication and/or data network 28. The system 20 further includes a services platform 24 and a media distribution system 26 which could be used to select and access movies, music, web pages or the like. The media distribution system 26 includes an in-room remote link (not shown) for a selection of desired media and is further connected to the services operation platform 24. The services platform 24 keeps track of the users that order desired media and may be linked to a mass storage system (not shown) containing stored media. Alternatively, desired media ordered by the guest is subscribed via the data network 28 from a (not shown) media server. The media distribution system 26 communicates with a (not shown) in-room remote control for a selection to access information. The media information is displayed via a (not shown) display within said guest room.

The media distribution system 26 includes an interface 30 for connecting to a guest's own mobile electronic appliance 32. Examples for such an appliance comprise a digi cam or video cam, an MP3-player, a PDA, etc. Preferably, the interface 30 is a standardized interface, e.g. USB™, FireWire™, IEEE 1394, LAN, Bluetooth™ interface or the like. The interface 30 is configured to support an up- and download of data between the media distribution system 26 and the mobile electronic appliance 32.

The software running at the distribution system 26 includes a user interface software supporting a connection of the mobile electronic appliance 32. The interface 30 as well as the software running on the distribution system 26 support an upload of audio data for personal wakeup service room service, download of vicinity data like current offers, addresses, opening times, theater programs/schedules, electronic brochures, etc. The interactive data exchange advantageously prevents the hotel or the guest to handle paper brochures. The result is a more flexible exchange of guest information and use of personal guest data.

In the other direction, an upload may be supported. In case the mobile electronic appliance 32 of the guest includes a storage for audio and/or video data, these data can be uploaded and played at screen or the loudspeakers of the guest room. Alternatively, the guest might wish to tune a wake-up call according to his favorite music.

The hotel may offer the guest to upload electronic photo data and print out of the photos on photo paper. Alternatively, the hotel may offer the guest to upload electronic video data and offer the guest a data carrier containing the data, e.g. a DVD.

Although the present invention has been described in accordance with the embodiments shown in the figures, one of ordinary skill in the art recognizes there could be variations to the embodiments and those variations would be within the spirit and scope of the present invention. Accordingly, many modifications may be made by one of ordinary skills in the art without departing from the spirit and scope of present invention, the scope of which is defined solely by the appended claims.

1. A hospitality system, comprising:
a media distribution system with a selection to access information and configured to direct information to a display within a guest room; and
a link connecting the media distribution system and a services platform to transmit information between the services platform and the media distribution system, wherein the media distribution system has an interface configured to be connected with a mobile electronic appliance and for exchanging data with the appliance.

2. The hospitality system as claimed in claim 1, wherein data are interactively exchanged between the appliance and the media distribution system.

3. The hospitality system as claimed in claim 1, further comprising a configuration to store information regarding guests utilizing guest rooms, wherein the mobile electronic appliance is a guests mobile electronic appliance.

4. The hospitality system as claimed in claim 3, wherein the media distribution system includes a user interface to support an exchange of data with the mobile electronic appliance.

5. The hospitality system as claimed in claim 3, wherein the mobile electronic appliance is a personal digital assistant.

6. The hospitality system as claimed in claim 3, wherein the mobile electronic appliance is a mobile phone.

7. The hospitality system as claimed in claim 3, wherein the mobile electronic appliance is a digital camera.

8. The hospitality system as claimed in claim 3, wherein the mobile electronic appliance is a portable computer.

9. The hospitality system as claimed in claim 1, wherein the interface is selected from the group consisting of a USB interface, an IEEE 1394 interface, a FireWire interface, a LAN interface, a Bluetooth interface and a combination thereof.

10. The hospitality system as claimed in claim 1, wherein the system is adapted to a usage within a hotel guest system.

11. A method for using a hospitality system, comprising:
providing a hospitality system having:
a media distribution system configured to direct information to a display within a guest room, and
a link connecting the media distribution system and a services platform to transmit information between the services platform and the media distribution system, wherein the media distribution system has an interface configured to be connected with a mobile electronic appliance and for exchanging data with the appliance;
providing the mobile electronic appliance by a guest;
connecting the mobile electronic appliance to the hospitality system by the guest;
uploading data from the mobile electronic appliance to the hospitality system by the guest;
disconnecting the mobile electronic appliance from the hospitality system by the guest; and
removing the mobile electronic appliance from the guest room by the guest.

12. The method as claimed in claim 11, wherein the media distribution system has a selection to access information.

13. A method for using a hospitality system, comprising:
providing a hospitality system having:
a media distribution system with a selection to access information and configured to direct information to a display within a guest room, and
a link connecting the media distribution system and a services platform to transmit information between the services platform and the media distribution system, wherein the media distribution system has an interface configured to be connected with a mobile electronic appliance and for exchanging data with the appliance;
providing the mobile electronic appliance by a guest;
connecting the mobile electronic appliance to the hospitality system by the guest;
downloading data from the hospitality system to the mobile electronic appliance; and
disconnecting the mobile electronic appliance from the hospitality system by the guest.

14. The method as claimed in claim 13, wherein the media distribution system has a selection to access information.

15. The method as claimed in claim 14, wherein the data downloaded is selected in the media distribution system.

16. The method as claimed in claim 13, wherein the guest is leaving the guest room with the mobile electronic appliance and the data downloaded.
